(19) United States
(12) Patent Application Publication
(10) Pub. No.: US 2011/0118020 A1
(43) Pub. Date: May 19, 2011

(54) Gaming machine with win announcement

(76) Inventor: Robert Manz, Las Vegas, NV (US)

(21) Appl. No.: 12/924,369

(22) Filed: Sep. 24, 2010

Related U.S. Application Data
(63) Continuation of application No. 11/492,540, filed on Jul. 24, 2006, now abandoned.
Application No. 11/492,540 is a continuation of application No. 10/202,707, filed on Jul. 24, 2002, now abandoned.

(51) Int. Cl. G06F 17/00

(52) U.S. Cl. 463/35

(57) ABSTRACT

A game machine having a win announcement feature and a method of providing an announcement regarding a winning event or outcome of a game played at a gaming machine are disclosed. One embodiment of a method comprises providing information regarding a winning event occurring at a gaming machine, the method including the steps of presenting a game to a player at a gaming machine, determining if the outcome of the game is a winning outcome, and if so, disseminating at the gaming machine a win announcement comprising information regarding the type of win and the source of the win. A gaming machine includes a controller configured to generate gaming machine control information for presenting a game and configured to generate win announcement information in the event the outcome of a game presented is a winning outcome, the gaming machine including at least one device for disseminating the win information.

### PRIOR APPLICATION DATA

This application is a continuation of U.S. application Ser. No. 11/492,540, filed Jul. 24, 2006, which is a continuation of U.S. application Ser. No. 10/202,707, filed Jul. 24, 2002, now abandoned.

### FIELD OF THE INVENTION

The present invention relates to gaming machines and other devices arranged to present one or more games and more particularly to a gaming machine configured to present win information.

### BACKGROUND OF THE INVENTION

While players may play gaming machines for entertainment and other purposes, the primary goal of all players is to achieve a winning outcome when playing the machine. In the case of gambling machines, players place bets in an attempt to achieve a large winning payout.

Because players play games for this purpose, gaming machines are generally configured to provide an indication of a win. For example, in the event of a win, the number of credits or monies won may be displayed to the player.

Casinos also desire that players be provided an indication of a game win. When a player wins, it further entices the player to play the game in an attempt to obtain additional game wins.

In some instances, flashing lights may be used to indicate to a player that they have received a winning outcome playing the machine. While such an indication is useful to the player playing the game, it does not fully serve the desire of the casino to provide notice to other players or potential players of the win, which may entice them to play as well.

A familiar sound at casinos and other gambling establishments is the sound of coins dropping into the coin tray. This sound may serve as an indication that someone has received a winning outcome. However, in many instances it solely represents a player cashing out. Thus, while the sounds of coins dropping may have the effect of catching the attention of other players or prospective players, the sound often does not reach the players and is not always indicative of a win.

A means for providing indication of a win which is useful to both a casino in informing other players and potential players of the win, and which is informative to the player of the game, is desired.

### SUMMARY OF THE INVENTION

The present invention is a gaming machine which includes a win announcement feature and a method of providing an announcement regarding a winning event or outcome of a game played at a gaming machine.

One embodiment of a method comprises providing information regarding a winning event occurring at a gaming machine. This method includes the steps of presenting a game to a player at a gaming machine, determining if the outcome of the game presented to the player is a winning outcome, and if the outcome is a winning outcome, disseminating at the gaming machine a win announcement, the win announcement comprising information regarding the type of win and the source of the win.

In one embodiment, the method is implemented at a gaming machine including at least one controller. The controller is configured to generate gaming machine control information for presenting a game at the gaming machine, and is configured to generate win announcement information in the event the outcome of a game presented at the gaming machine is a winning outcome, the gaming machine including at least one device for disseminating win information in response to the generated win announcement information.

In one embodiment, the win announcement includes both audible and visual information. In a preferred embodiment, the method includes the step of first generating an audible alert, such as the sound of a bell using a speaker of the gaming machine. Thereafter, the method includes the step of audibly presenting the win information. The win information may also be displayed visually, such as by a main game display or secondary “win” or other display of the gaming machine.

In the preferred embodiment, the win information comprises information regarding the type of the win, such as the number of credits or the monetary value the win. The source of win information may comprise an identification of the game which was being played or the gaming machine at which the win occurred.

In one embodiment, a win announcement is generated only in response to certain winning outcomes. For example, a win announcement is generated only in response to winning outcomes which are less likely to occur than others, or which are associated with particularly large payouts.

In one embodiment, the win announcement includes an identification of the player. For example, the player's identity may be obtained from a player tracking system.

In accordance with the invention, a win announcement is generated which provides information to not only the player of the gaming machine but other players and patrons in the vicinity of the gaming machine. The win announcement informs these parties of information regarding the win, such as the size or type of the win and its source. In this manner, players and patrons are provided with useful game play information.

Further objects, features, and advantages of the present invention over the prior art will become apparent from the detailed description of the drawings which follows, when considered with the attached figures.

### DESCRIPTION OF THE DRAWINGS

FIG. 1 is a perspective view of a gaming machine in accordance with the present invention;

FIG. 2 is a block diagram of a system for implementation of the present invention; and

FIG. 3 is a flow diagram of a method of disseminating a win announcement.

### DETAILED DESCRIPTION OF THE INVENTION

The present invention is a gaming machine which includes a win announcement feature and a method of providing win information. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the present invention comprises a gaming machine having a win announcement feature. Upon the occurrence of one or more winning events or outcomes, certain information pertaining to the winning event is disseminated. The announcement may include audible and/or visual information, and preferably includes information regarding the source of the win and the size of the win.

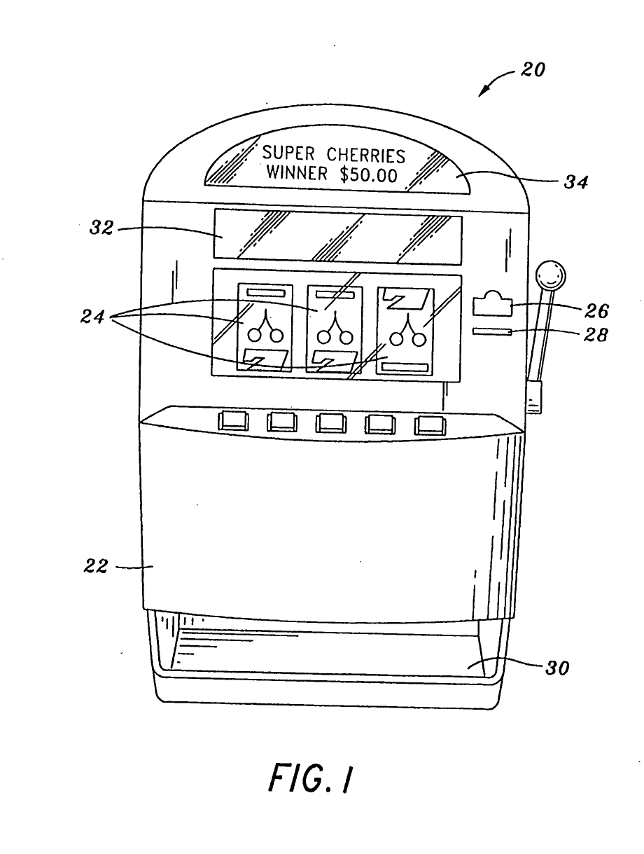

Referring to FIG. 1, there is illustrated a gaming machine 20 in accordance with one embodiment of the present invention. In general, the gaming machine 20 is adapted to present one or more games for play to a player. As illustrated, the gaming machine 20 comprises a housing or cabinet 22 for supporting and/or housing various components of the gaming machine 20. In the embodiment illustrated, the gaming machine 20 is adapted to present a game of slots and includes one or more rotatable reels 24. In another embodiment, the gaming machine 20 may be configured as a video-type machine and include other components, such as a video display.

Preferably, the gaming machine 20 is configured to present one or more games to a player dependent upon a player placing a wager or bet, and in the event the outcome of the game is one or more predefined winning outcomes, pay the player a winning. As such, the gaming machine 20 includes a mechanism for accepting a wager or a bet. As illustrated, a coin acceptor 26 is provided for accepting coins. The gaming machine 20 also as illustrated includes a bill acceptor or validator 28 for accepting paper currency. In one or more embodiments, other mechanisms may be provided for accepting a wager, such as a card or ticket reader.

The gaming machines 20 may include a variety of other components, as are known. For example, the gaming machine 20 may include a plurality of input devices. These input devices may include one or more buttons, such as a “play credit” button and/or a “bet max” button for permitting a player to place wagers from a pool of credits won or paid by the player. The input devices may include a “spin reels” button or a pull-type handle for effecting the spinning of the reels.

In a preferred embodiment, a player is awarded a payout in the event the outcome of the game is a winning outcome. In one or more embodiments, the amount of the award is based on the amount wagered by the player and/or the odds of receiving the particular outcome. The payout may comprise credit, actual monies or other items of value or representative of value, such as a ticket or a physical prize.

When the player is paid in the form of stored credits, the number of credits is indicated to the player. A “cash out” button is preferably provided for permitting a player to be paid the stored credits. In one embodiment, the means for paying a player comprises a coin dispenser (not shown) for dispensing coins to a coin tray 30. A player may also be permitted to be paid their credits or winnings on a player card in electronic form, such as via a card reader/writer.

It should be understood that the gaming machine 20 may be adapted to present one or more of a wide variety of games. Depending upon the game presented, the configuration of the machine may vary. For example, in the event the gaming machine 20 is adapted to present a game of video poker, the gaming machine 20 may include a display (not shown) for displaying images of cards and other information.

In a preferred embodiment of the invention, the gaming machine 20 includes at least one speaker 32. The at least one speaker 32 allows for audible information to be presented. As will be described in greater detail below, in a preferred embodiment, the at least one speaker 32 allows for a player and other patrons to receive audible information pertaining to a winning event at the gaming machine.

As illustrated in FIG. 1, the gaming machine 20 preferably includes a win display 34. In one or more embodiments, the win display 34 is configured to display information pertaining to a winning outcome. The information may include, as detailed below, the name of the player, the amount won, and the name of the game, among other information. The win display 34 may comprise a wide variety of devices such as an LCD or LED display, or a CRT display. The win display 34 may comprise, as illustrated, a secondary display. This display may have other purposes, such as for use in displaying player tracking information, jackpot information, or a secondary or bonus game.

In one or more embodiments, the video display or displays used to present the game (such as in the case of a game configured to present the game of video poker) is also used as the win display. In another embodiment, the win display may be located remotely from the gaming machine. For example, the win display may comprise a central overhead display located adjacent to a single gaming machine or a plurality of gaming machines In another embodiment, a win display may be located at both the gaming machine and at another remote location.

It will be appreciated that the term gaming machine as used herein may apply to a variety of devices other than a gaming machine as illustrated in FIG. 1. That is in one or more embodiments, the term gaming machine may apply to a wide variety of devices or systems that are adapted to present a game to a player. For example, the device may comprise an arcade game, or a computing device configured to present a game, such as a player's home computer which is connected to a game server by a communication link. The gaming machine may be of the upright, bar-top or other variety, and may be located in a casino or other location. In one or more embodiments, the gaming machine need not be configured to pay winnings.

In a preferred embodiment, the gaming machine 20 is configured to generate a win announcement upon the occurrence of a winning event. The win announcement provides information pertaining to the winning event. Preferably, the information is provided both audibly and visually.

In a preferred embodiment, the gaming machine is configured to generate an alert before presenting the winning announcement. Preferably, the alert is followed by a silent pause before the announcement is made. This allows for all those within ear shot of the alert to focus their attention on the gaming machine before the winning information is presented. In one or more embodiments, the alert may comprise a variety of sounds including a bell or a whistle.

As is well known, gaming machines are generally electronically controlled. Even the mechanically rotating reels 24 are electronically controlled. In such a configuration, the stopping position of the reels 24 is determined by a random number generator, with motors/brakes used to spin and stop the reels in the random positions determined by the random number generator. Such as principal is disclosed in U.S. Pat. No. 4,448,419 to Telnaes.

In a preferred embodiment, the gaming machine 20 includes a master gaming controller 40. In general, the master gaming controller 40 is configured to generate information for controlling the operation of the gaming machine 20, including the various peripheral devices such as buttons, reels 24, etc. for the included purposes of presenting a game.

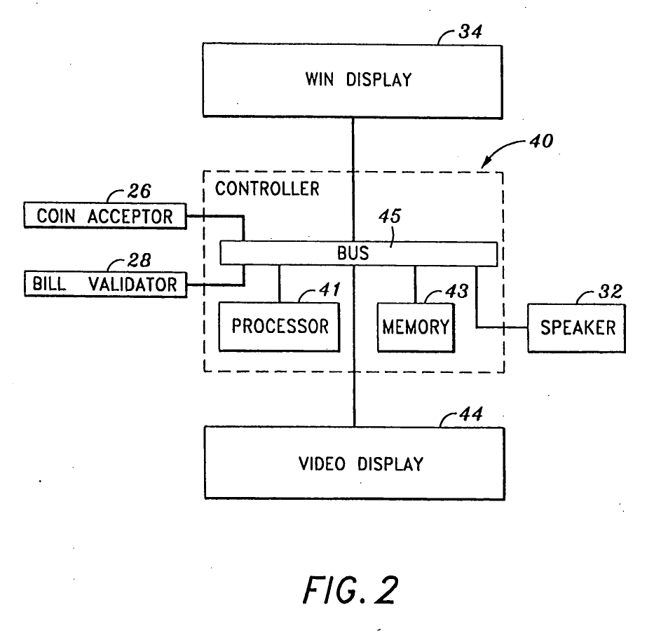

One embodiment of a master gaming controller 40 is illustrated in FIG. 2. The gaming controller 40 may have, however, a variety of configurations other than that illustrated. In one embodiment, the controller 40 includes a processor or processing device 41. In general, the processing device comprises a device capable of executing readable program code or data. In another embodiment, the processing device may comprise hardware which embodies the program code or data.

In the preferred embodiment, program code for use by the processing device 41 may be stored in a memory 43 or other information storage device for storing data. The processing device 41 and memory 43 are in communication with one another. In one embodiment, the processing device 41 and memory 43 are linked by a common system bus 45. The operation of the bus 45 is well known.

As detailed, the controller 40 is configured to control the various peripheral devices of the gaming machine 20. As such, in a preferred embodiment, the processing device 41 is preferably capable of receiving information or data from the peripherals, and send information or data, such as instructions, to those devices. As illustrated, in one or more embodiments, the coin acceptor 26 and bill validator 28 communicate with the processing device 41 via the bus 45. The other peripherals, such as the reels 24 and/or a video display 44 are coupled to the bus 45.

As indicated above, in a preferred embodiment, the gaming machine 20 includes a win display 34. This win display 34 is also associated with the controller 40, and more particularly, the processing device 42. This association permits the controller 40, upon a winning event, to cause the win display 34 to display information pertaining to the winning event.

In a preferred embodiment, the at least one speaker 32 is also associated with the controller 40. This association permits the controller 40 upon a winning event to cause the at least one speaker 32 to present audible win information.

It will be appreciated that in one or more embodiments, the gaming controller 40 of the gaming machine 20 is specifically configured to implement the method of the present invention. In this regard, machine readable program code may be provided, such as stored in memory, for this purpose. In another embodiment, the processor may be specifically configured to implement all or a portion of the method. The gaming controller 40 is configured to determine if a winning event has occurred and, if so, generate win announcement information. This information is used by information disseminating devices (i.e., speaker 32/display 34) to present win information.

In another embodiment, the gaming machine 20 may be configured to include a win announcement controller (not shown). In this configuration, a separate win announcement controller may be provided in communication with the master gaming controller 40. The win announcement controller may comprise software and/or hardware, such as a processor and memory for storing executable code. In this embodiment, the win display 34 and/or device or devices for presenting the other win announcement may be associated with the win announcement controller. In response to a signal from the master gaming controller 40, the separate win announcement controller may be configured to generate win announcement information. An example of a method of implementing the method of the invention using such a win announcement controller is described in more detail below.

In one embodiment, the master gaming controller 40 (or win announcement controller) may be associated with a player tracking system or other system. For example, the master gaming controller 40 may be associated with a security or game service system. This system may include one or more remote devices, such as one or more remote servers, such as for generating and transmitting game implementing software. These devices may be placed in communication with the master gaming controller 40 via a communication interface at the gaming machine 20. The communication interface may couple to the bus 45. A communication link, such as a wired or wireless link, is provided between the communication interface and the remote device, such as a communication interface of a remote server.

The player tracking system may comprise a system for tracking aspects of a player's game play at the gaming machine 20. The system may include one or more devices located at the gaming machine 20 itself, such as a media reader. The media reader may comprise, for example, a magnetic stripe card reader for reading information from a magnetic stripe of a player card. The reader may utilize information obtained from the player's media, such as player tracking card. This information may be transmitted to the remote host, such as a player tracking system host, to obtain information regarding the player of the gaming machine 20, and to track information regarding the player's play provided by the gaming machine.

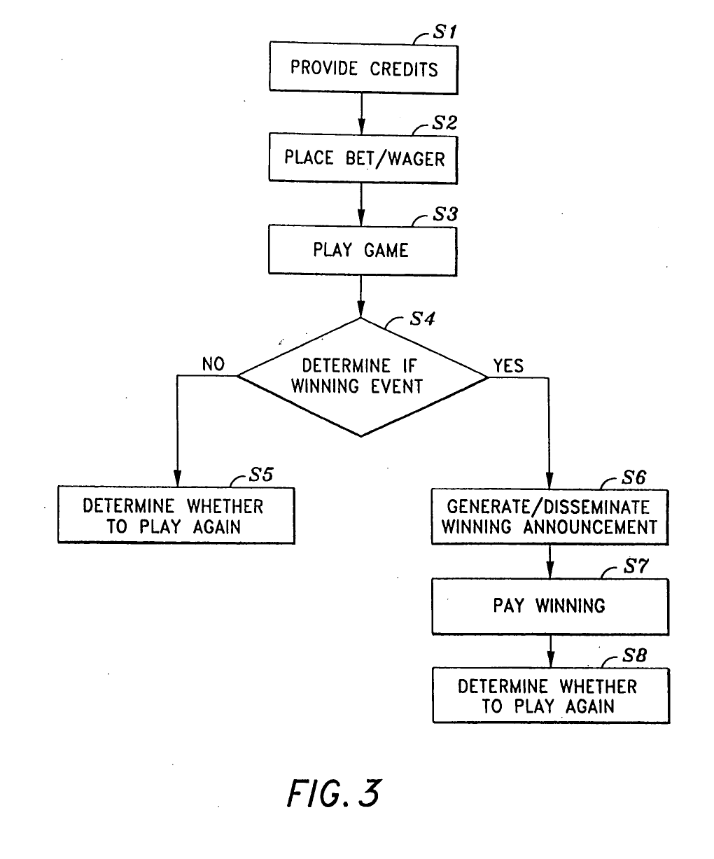

A method in accordance with a preferred embodiment of the invention will now be described with reference to FIG. 3. In a step S1 a player provides value to a gaming machine, such as by inserting coins, currency/bills, swiping a credit card, or the like. In one embodiment, this value is represented as “credits” which the player may utilize. Next, in a step S2, the player places a bet or wager. In one or more embodiments, this may be accomplished by the player depressing one or more times a bet credit button, or a bet max button or other input.

In a step S3, a game is presented to a player and the player plays the game. In one embodiment, a player may be permitted to select among a variety of games to play. Once a game is selected and a bet or wager is placed, the game is presented to the player. The play of the game, as is well known in the art, may require various inputs by a player.

In a step S4, it is determined whether the outcome of the game is a winning outcome. In one embodiment, this step comprises comparing the outcome to one or more predetermined winning outcomes. The predetermined winning outcomes may depend on a variety of factors, including the type of game played and the desired odds of receiving winning outcomes.

If in a step S5 if it is determined that the player has not received a winning event, the player is presented with the option to play the game again. If the player chooses to play again, the method starts over at steps S1 or S2 (depending if the player has remaining credits).

In a step S6, if it is determined that a winning outcome occurred, a winning announcement is generated and presented or disseminated. In one embodiment, the step of generating and presenting the winning announcement is implemented by the master gaming controller 40 of the gaming machine 20 configured as detailed above.

In one embodiment, a winning announcement is generated and presented in response to each/any winning outcome. In another embodiment, a winning announcement is generated and presented in response to only particular winning outcomes. For example, in one embodiment, a minimum winning may be required or a minimum wager may be necessary before a winning outcome becomes one which triggers a win announcement. By way of further example, in the case of video poker, a winning outcome which pays an amount equal to the player's wager may be received if the player receives a pair of Jacks. This winning outcome is received with the highest frequency of all of the winning outcomes. In one embodiment, only outcomes comprising higher poker hands, such as Straights, Flushes or the like may trigger a win announcement.

In a preferred embodiment, the win announcement comprises both audible and visual information. In one embodiment, audible information may be presented through the at least one speaker 32 of the gaming machine 20 configured as illustrated in FIG. 1.

In one or more embodiments, the information is visually displayed, such as using a main display or a win display of the gaming machine. The information displayed may comprise more or less information than the information that is audibly announced.

In a preferred embodiment, the winning announcement includes an initial audible alert. This alert may comprise, for example, the generation and dissemination of the sound of a bell, whistle or the like. This sound may be generated by one or more speakers. In another embodiment, the gaming machine may be provided with a bell or the like. In this configuration, a first audible alert is generated and disseminated which is used to gain the attention of players and patrons within the vicinity of the gaming machine where the winning event occurred.

Preferably, the win announcement comprises an announcement after the alert. In this embodiment, there is a pause between the alert and the announcement.

In a preferred embodiment, the win announcement comprises the presentation of information regarding the nature, type, or size of the win and source of the win. In another embodiment, the win announcement may comprise or include the name or identification of the player. One embodiment of a win announcement comprises the visual display and audible presentation of this information.

Various embodiments of win announcements are set forth below:

“Congratulations! Another winner on the (name of gaming machine).” For example, “Congratulations! Another winner on the Super Cherries gaming machine.”

“Congratulations (name) is a winner of (number of credits or monetary value) on the (name of gaming machine).” For example, in this embodiment, the win announcement might be as follows: “Congratulations John Doe is a winner of $1000.00 on the Super Cherries gaming machine.”

“$(value) winner on the (name) game.” For example, “$100.00 winner on the Super Cherries game.”

“Congratulations, you are the (number) winner of a $500 jackpot on the Super Cherries game.” For example, “Congratulations, you are the 800^{th} winner of a $500 jackpot on the Super Cherries game.”

In the preferred embodiment, the win announcement comprises information regarding the amount of the win, such as the number of credits or the monetary value of the win. In the preferred embodiment, the win announcement also comprises information regarding the source of the win, either the particular game played or the gaming machine played. For example, the source of win information may comprise the name of the game played or the name of the gaming machine. The source of win information may also comprise or include information regarding the location of the machine.

The win announcement may include or comprise other information. For example, as detailed above, the win announcement may provide information regarding how many wins have been received total, or over a specific period of time. For example, “Congratulations, you are the 50^{th} winner of a Royal Flush this month on Jacks or Better Video Poker.”

Preferably, the win information is presented audibly, and sufficiently loud that other player/patrons in the vicinity of the gaming machine receive the information. The exact loudness may depend on a variety of circumstances/factors. Preferably, however, player/patrons many feet away (at least 20-100 feet) are capable of receiving the information.

In the preferred embodiment, the win announcement comprises a means for informing players and patrons other than the player of the gaming machine who just received the winning outcome of that winning outcome. Thus, the win announcement preferably comprises visual and/or audible information which reaches these other parties, and which provides them information which allows them to identify that a win has resulted and the source of the win (i.e., particular gaming machine or game played).

The method of the invention may apply to any gaming machine, and to any win or similar event at a gaming machine. Thus, the invention applies to different types of gaming machines and gaming machines presenting different games. For example, the gaming machine may be configured to present the game of video poker, slots or other games. Preferably, the win announcement in accordance with the invention is specifically tailored to the particular gaming machine or game which was played at the gaming machine which yielded the winning event. For example, in the case of a video poker gaming machine, the win announcement may be “Congratulations, another Four of a Kind win of $200 on Double Double Poker.”

In one or more embodiments, the winning announcement may be presented more than once. In one embodiment, the visual information is left on the win display until the next winning event. For example, list of winners may be displayed or the name of the game that had the winning event may be listed. Of course it is contemplated that other information may be displayed, such as winners or winning events based upon a variety of criteria including by game or game type (including multiplier, line, option buy, section of device, denomination or entire casino). In another embodiment, listings of winning events are displayed at the win display for a specific amount of Jul. 18, 2002, time or for a specific number of winning events.

It is also contemplated that the win announcement may vary. The announcement may vary dependent upon the winning outcome which is received, the time it is received or the like.

In one or more embodiments, the winning announcement may apply even when the winnings awarded are not monies. For example, casinos often reward players for playing a game associated with the gaming machine for long periods of time or for wagering certain amounts with complimentary awards (“comps”) of free or reduced cost goods and/or services (i.e. food, motel room, credits for play at the gaming machine). In one embodiment, an announcement would be generated in recognition of such a reward. For example, “Congratulations, you have just won two free nights' stay playing the Super Cherries Machine.” In this regard, the winning announcement may be disseminated when the winning event is other than a “game win,” but includes events where other awards are provided.

As indicated, in one embodiment, the player's name may be presented in the win announcement. The player's name may be obtained, for example, using a player tracking system in a manner described in greater detail above. In another embodiment, the player's name may not be available, and then the win announcement need not include the player's name.

In a step S7, the player is paid his/her winnings, and in a step S8, the player is presented with the option to play the game again.

As indicated, the method of the invention may be presented on a gaming machine such as gaming machine 20 described above and illustrated in FIG. 1. The method of the invention may be presented in other manners and using other devices.

The method and gaming machine in accordance with the present invention have numerous advantages. First, in accordance with the invention, information regarding winning outcomes at a gaming machine is provided. The manner by which the information is provided disseminates the information to not only the player of the gaming machine, but other players and patrons in the vicinity of the gaming machine. In a preferred embodiment, the information is presented audibly, and thus reaches players which may not be in the line of sight with the win display or other display of the gaming machine.

In the preferred embodiment, the invention has specific advantages relating to the particular information which is disseminated. In particular, the information permits players and patrons to identify the size of the win, as well as the source of the win. The source may comprise a particular gaming machine or a particular type of game presented on a gaming machine.

The invention has particular advantages to players and patrons. In accordance with the invention, players and patrons are informed that a particular gaming machine or a particular game is yielding winning outcomes. This allows a player or patron to identify a gaming machine or game which they may desire to play to improve their probability of winning. In this regard, it is noted that various gaming machines are often configured to have different rates of payout or return. It is very difficult for a player to determine the difference in the rate of return. In accordance with the present invention, a player is presented with information regarding winning outcomes, and therefore can determine that a particular machine or particular game is yielding winnings more often.

The invention also has advantages to the casino. In accordance with the invention, the fact that winning events are occurring is announced to players and patrons. This furthers player and patron desire to play the gaming machines.

Other embodiments of the invention are contemplated. In one embodiment, the win announcement or winning event information may be disseminated through central displays or sound systems with which one or more gaming machines are associated. For example, win information resulting from the play of a number of machines may be presented through a central casino sound system. The win information may be generated at the gaming machine and transmitted to the system, such as via a network. Alternatively, the win information may be generated remotely in response to a win signal from a gaming machine.

In some embodiments, game play information may be generated remotely and be transmitted to the gaming machine. For example, a remote server may generate and transmit game play information to remote gaming machine. In such configuration, the win information may also be generated remotely and then be transmitted to the gaming machine presentation.

In one embodiment, the win announcement feature may be implemented at a gaming machine which is associated with a group of machines that are linked together. For example, winning information pertaining to a winner of a tournament may be presented at one or more of the linked gaming machines. A winning announcement may be provided to the players of all linked gaming machines when a player at one of those machines wins a linked jackpot. As detailed above, the win announcement may include the player's name (such as obtained from a player tracking or entry system).

As described above, the winning game or event which triggers the win announcement may vary. As one example, the win event may comprise the award of a complimentary award based on other than a winning game outcome. As another example, some gaming machines present games having a main game and a bonus event. The bonus event may comprise the display of a game on another screen, the spin of a bonus reel or wheel or the like. Other games include sub-games, or a different “game within the main game.” An announcement may be generated and disseminated in the event that a player qualifies for play of a bonus event or the play of a sub-game. For example, if a player receives a particular symbol or group of symbols which entitles the player to payout or to participate in a bonus event, the win announcement may be provided. In another embodiment, the win announcement may be triggered by winning bonus game or sub-game associated with the underlying game presented at the gaming machine.

It will be understood that the above described arrangements of apparatus and the method therefrom are merely illustrative of applications of the principles of this invention and many other embodiments and modifications may be made without departing from the spirit and scope of the invention as defined in the claims.

What is claimed is:

1. A gaming machine having a win announcement feature, said gaming machine having a name identified at said gaming machine, said gaming machine comprising at least one controller configured to generate gaming machine control information for presenting a game at said gaming machine, said game having a name identified at said gaming machine, and configured to generate win announcement information in the event the outcome of a game presented at said gaming machine is a winning outcome, said gaming machine including at least one device for disseminating externally audible win information in response to said generated win announcement information to persons in a vicinity of the gaming machine, said win announcement information comprising a first audible alert followed by audible dissemination of information regarding the amount or value of an award associated with said winning outcome and at least one of said name of the game and said name of the gaming machine comprising the source of said winning outcome in a manner permitting a patron to identity the gaming machine at which the award was yielded without being the line of sight of said machine.

2. The gaming machine in accordance with claim 1 wherein said audible win information disseminated by said gaming machine includes both information identifying the game being played which resulted in the winning outcome and the gaming machine which presented said game.

3. The gaming machine in accordance with claim 1 wherein said at least one device comprises one or more speakers.

4. The gaming machine in accordance with claim 1 wherein said gaming machine includes a main gaming controller and a win announcement controller, said win announcement controller configured to generate win announcement information in response to a signal from said main gaming controller that an outcome of a game presented at said gaming machine is a winning outcome.

5. A method of providing information regarding a winning event occurring at a gaming machine comprising the steps of:
presenting a game to a player at a gaming machine, said game having a name identified at said gaming machine;
determining if the outcome of said game presented to said player is a winning outcome; and if said outcome is a winning outcome meeting a minimum award threshold for announcing the win, disseminating at said gaming machine a win announcement, said win announcement comprising externally audible information regarding a value of said award for said game win and said name of the game which was won, said audible information disseminated at sufficient volume to alert persons in a vicinity of the gaming machine of said win.

6. The method in accordance with claim 5 wherein said minimum award threshold comprises a minimum value of an award for said winning outcome.

7. The method in accordance with claim 5 wherein said win announcement additionally comprises visual information.

8. The method in accordance with claim 5 including the step of accepting a wager from said player and paying a winning award in the event said outcome is a winning outcome.

9. The method in accordance with claim 5 wherein said winning announcement includes a first audible alert followed by pause, followed by said audible information.

10. The method in accordance with claim 5 wherein said type of win comprises a monetary value.

11. The method in accordance with claim 5 wherein said source of the win comprises information sufficient to permit third parties to identify the gaming machine at which said winning outcome occurred.

12. The method in accordance with claim 5 wherein said source of the win comprises information regarding the name of the game played which resulted in the winning outcome.

13. The method in accordance with claim 5 wherein said information comprising said win announcement includes the name of the winner, the amount of the win and the game played.

14. A gaming machine win announcement system for a casino comprising two or more gaming machines configured to present wagering games and having a win announcement, said gaming machines with win announcement each comprising at least one controller configured to generate gaming machine control information for presenting a game, said two or more gaming machines configured to present different games from one another, each game having a game name, and said gaming machines configured to generate win announcement information in the event the outcome of a game presented at said gaming machine is a winning outcome, said gaming machines each including at least one device for disseminating externally audible win information in response to said generated win announcement information to persons in a vicinity of the gaming machine with win announcement, said win announcement information comprising a first audible alert followed by audible dissemination of information regarding the amount or value of an award associated with said winning outcome and information identifying the game which was won by game name, whereby patrons of said casino may distinguish between winning outcomes of said different games via said win announcement information and without being in visual contact with said gaming machines generating said win announcement information.

15. The gaming machine win notification system in accordance with claim 14 wherein said win announcement information includes information regarding a number of winning game results at said gaming machine.
